(19) United States
(12) Patent Application Publication
(10) Pub. No.: US 2002/0037443 A1
(43) Pub. Date: Mar. 28, 2002

(54) Method of controlling a fuel cell system

(75) Inventors: Andreas Christen, Allendorf (DE); Steffen Wieland, Heilbronn (DE)

Correspondence Address: THE FIRM OF KARL F ROSS, 5676 RIVERDALE AVENUE, PO BOX 900, RIVERDALE (BRONX), NY, 10471-0900, US

(73) Assignee: BUDERUS HEIZTECHNIK GmbH

(21) Appl. No.: 09/921,447

(22) Filed: Aug. 2, 2001

(30) Foreign Application Priority Data
Aug. 2, 2000 (DE) 10037579.0

(51) Int. Cl. H01M 8/04

(52) U.S. Cl. 429/13; 429/23; 429/24

(57) ABSTRACT

A fuel-cell system controls the thermal and electrical outputs to the load points of the thermal and/or electrical load exclusively by turning on and off individual fuel cells or fuel-cell stacks.

### FIELD OF THE INVENTION

Our present invention relates to a method of controlling a fuel-cell system and particularly a fuel-cell system which is comprised of an assembly of individual cells or fuel-cell stacks having a fuel preparation unit and connected to an electrical and/or thermal load utilizing the energy produced. The invention also relates to an apparatus for that purpose.

### BACKGROUND OF THE INVENTION

Fuel-cell assemblies have been used as power/heat coupling units to supply electrical power to the electrical part of a load and thermal power to heating systems and the like and generally transform hydrogen or hydrocarbon-containing fuels directly into electric current. A characteristic of such fuel cells is that the highest electrical efficiencies are obtained with the lowest current densities and electrical and thermal powers are normally quite low for each of the units, i.e. for individual fuel cells or stacks. With increasing current density, the electrical efficiency of the fuel cell tends to continuously drop although the amount of heat produced and the amount of electrical energy produced are greater. The greatest electrical power is obtained at relatively high current density. At still further increases in current density, however, the electrical power preparation or efficiency falls rapidly and the thermal output and efficiency increases sharply. The latter reaches its maximum at load points corresponding to maximum current density, i.e. a voltage of zero.

Fuel-cell systems generally comprise a large amount of individual cells and groups of such cells in so-called stacks and which are connected in series or in parallel or both. The individual cells and stacks have nominal load points. The assembly itself thus has a load point depending upon the number of individual cells and stacks connected therein. Because the energy consumption fluctuates, the fuel cells are operated with varying current density, usually at the load end of the current density range and thus seldom at their nominal load points. The variable and actual load point is thus always a compromise between efficiency and power output.

When the fuel-cell system is used as a power/heat coupling unit to cover the electric current and heat demands of an object, the fuel-cell system must often be matched to the significantly fluctuating power demands of the load or energy consumer in order to ensure a satisfactory efficiency of the apparatus. This also may affect the feeding of electric current to a power network which will depend upon time limitations and fee recoveries, both of which can affect efficient operation of a fuel-cell system.

Power/heat coupling units which must be controlled in accordance with the thermal demand can be utilized to produce electric current for delivery into open networks. On the other hand, the fuel-cell system may supply a load having a certain electric current demand. In the latter case the electric power which is produced becomes the determining factor and the heat which is generated in parallel therewith must be conducted away.

German patent document 198 27 880 C1 describes a fuel-cell assembly with a series connection of the fuel cells. With additionally provided and integrated components, the fuel cell can be shunted by low-ohmic circuitry in parallel to cut off one or another of the fuel cell. This prevents, upon the occurrence of a failure, for example upon polarity reversal, damage to the individual fuel cell or the overall system. In addition, German patent document DE 199 56 225 A1 describes a fuel-cell arrangement which utilizes a characteristic field memory for controlling the air quantity. For that system experimentally obtained values are stored for a variety of possible operating states.

### OBJECTS OF THE INVENTION

It is the principal object of the present invention to provide a method of operating a fuel-cell system at an optimum load point with respect especially to the best efficiency as well as maximum heat and/or current availability for any particular purpose.

Another object is to provide an improved method of operating a composite fuel-cell system consisting of an assembly of individual fuel cells and/or fuel-cell stacks, whereby drawbacks of earlier systems are avoided.

Another object of this invention is to provide a fuel-cell system which can be operated with greater efficiency and more closely to the load points determined by thermal and/or electrical load.

### SUMMARY OF THE INVENTION

These objects are attained, in accordance with the invention, in a method of controlling a fuel-cell system which comprises:

(a) connecting a multiplicity of individual electric power generating units selected from individual fuel cells and fuel-cell stacks in an assembly by electrical connections selected from series and parallel connections, thereby generating electric power and producing heat for at least one energy consuming load; and

(b) controlling power produced by the assembly to match an actual load point of the load and electrical current density required by the load exclusively by cutting off and turning on one or more of the units.

More particularly, in a process for controlling a fuel-cell system in which a multiplicity of individual cells or stacks are combined in an assembly and wherein there is a device for fuel preparation or supply as well as a connection of the assembly to at least one electrical and/or thermal load or energy-consuming device for utilizing the generated energy, and especially an assembly capable of use as a power/heat coupling unit which can have a heating system as well as a device utilizing the electric energy, e.g. a network to which electrical energy is delivered, the individual cells or stacks are shut off or turned on separately or in combination based upon the current density which is required for the load at the actual load point thereof and to regulate the electrical and/or thermal power of the fuel-cell system.

The fuel-cell system can be controlled as a function of the electrical and thermal load connected thereto and, according to a feature of the invention, the turning on and the turning off of individual cells or stacks is so effected that the remaining individual cells or stacks are as close as possible to the load point which is most desirable for the energy consuming load at the particular time and selectively for the energy which is then in use or the energy which is then required in preparation for the maximum electrical and/or thermal energy required for that load at that time.

The shutting off or turning on of the individual cells and stacks can be effected in accordance with the demand requirements of the electrical or thermal load connected to the assembly and so that the remaining cells or stacks in operation can supply the demands as close as possible to the most effective load point.

It has been found to be advantageous to control the fuel-cell system for the optimal load point of the thermal load by ignoring the maximum electrical efficiency thereby obtaining a greater thermal power. Similarly, the control of the fuel-cell system for the electrical load at its optimum load point can ignore the highest possible thermal efficiency to thereby maximize the electrical power output.

The shutting off and turning of the individual cells or stacks can be effected stepwise and can be compensated or balanced by an associate modulation of the individual cells or stacks remaining in operation. The control of the fuel-cell system may be effected by a temperature measurement in the region of the connection of the assembly to the thermal load and/or by a temperature measurement in a heating unit connected thereto.

The individual cells or stacks of the assembly can, in the latter case, have different power parameters and characteristics, or different nominal load points, especially with respect to the current density. In apparatus terms, the fuel cell system can comprise:

a multiplicity of individual electric power generating units selected from individual fuel cells and fuel-cell stacks connected in an assembly by electrical connections selected from series and parallel connections, thereby generating electric power and producing heat for at least one energy consuming load; and

respective bridges connected across the units for controlling power produced by the assembly to match an actual load point of the load and electrical current density required by the load exclusively by cutting off and turning on one or more of the units.

In addition the fuel-cell system can comprise:

a multiplicity of individual electric power generating units selected from individual fuel cells and fuel-cell stacks connected in an assembly by electrical connections selected from series and parallel connections, thereby generating electric power and producing heat for at least one energy consuming load; and

an electrical network monitor connected to an electrical member of the load for controlling power produced by the assembly exclusively by cutting off and turning on one or more of the units.

The method of the invention utilizes the fact that the assembly is matched to the actual load point of the electrical and/or thermal requirements of the load by turning on or turning off individual fuel cells or fuel-cell stacks in appropriate combinations, e.g. by the use of bridges connected across those fuel cells or stacks and which can be, for example, shunt the input and output electrical terminals thereof. The optimal load point can be that determined by the current density.

The stacks or fuel cells remaining in operation should match or be as close to the most effective load point for the particular load. The load point which is matched can be selectively the electrical load point or the thermal load point. The result is an internal optimization of the assembly of fuel cells and of the system.

### BRIEF DESCRIPTION OF THE DRAWING

The above and other objects, features, and advantages will become more readily apparent from the following description, reference being made to the accompanying drawing in which:

FIG. 1 is a graph in which voltage is plotted along the ordinate against current density along the abscissa for a fuel cell in accordance with the invention; and

FIG. 2 is a diagram facilitating an understanding of the invention.

### SPECIFIC DESCRIPTION

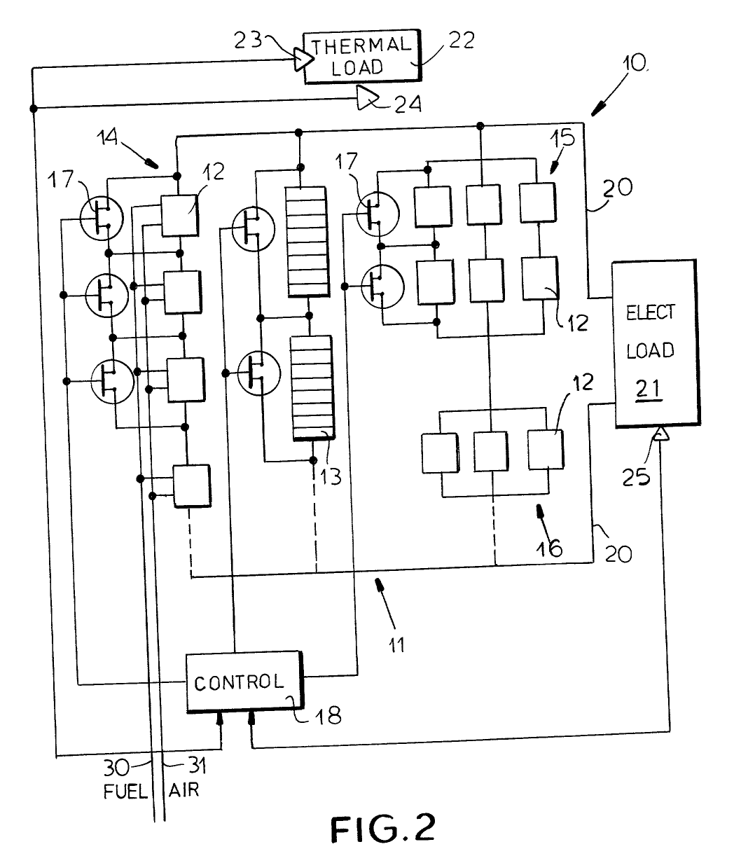

Referring first to FIG. 2, it can be seen that a fuel-cell system 10 can comprise an assembly 11 of individual fuel cells 12 or fuel-cell stacks 13 which are connected, e.g. as represented at 14 in series or as represented at 15 in parallel or as shown diagrammatically at 16 in series connections of parallel fuel cells 12 or stacks 13. The individual fuel cells or stacks are themselves provided with bridge circuits represented diagrammatically at 17 operated by a controller 18 and which serve to cut out individual fuel cells or stacks thereof or to enable those stacks to be connected in the assembly. Those fuel cells and stacks which are not cut out by the bridges are the remaining fuel cells and stacks and contribute to the output of the system. The assembly can be electrically connected via the conductors 20, for example, to an electric load or network 21 and the thermal output of the assembly 11 may be applied to a thermal load or heating plant 22.

The combination of the electrical load 21 and the thermal load 22 forms the energy consumption unit serviced by the assembly. The control unit 18 which functions in the manner which has already been described and which will be described further hereinafter forms the energy consuming unit whose load point via the controller 18 turns on and off the individual fuel cells or stacks. Inputs to the controller 18 may be formed by temperature sensors 23 responsive to the temperature within the thermal load 24, or responsive to the temperature at the connection between the thermal load and the fuel-cell assembly. Another input may provide feedback of an electrical load parameter at 25, for example, a load point which is a function of current density.

In FIG. 2, the preparation and delivery of the fuel is represented at 30 while air supply to the fuel cells is represented at 31.

In addition or as an alternative to the load point control previously described and hence the optimization of operation, as a criterium for the turning on and turning off of the individual cells or stacks, we can use the demand requirements of the electrical load 21 and the thermal load 23. All of the individual cells or stacks remaining in operation serve to bring the assembly as close as possible to the most desirable load point for the respective demand requirement with only certain external influences, such as the inputs from the heating unit or electrical load having priority at the controller 18.

In the control of the fuel-cell system based primarily upon the thermal load 22, the optimum load point for maximum electrical efficiency can be ignored to ensure that a correspondingly greater heat output is provided. In the reference case in which the load point of the electrical load is to be the dominant factor, the load point for the maximum thermal efficiency can be ignored to maximize the electric power outputted, i.e. when the fuel cell is utilized predominantly to supply electrical power.

As a result, the system affords a high degree of flexibility to matching the assembly to the requirements of a power/heat coupling system.

Current and thermal spikes can be avoided when, during the stepwise turning on and off of individual cells or stacks, there is an associated modulation of the remaining individual cells or stacks to compensate for such peaks. In the compensation, in the event of a change in demand, for example, there is an initial switching on or off of individual cells or stacks and thereafter a brief alteration of the control point with priority over other effects, indicating temporarily optional load points.

The inputs at 23 and 24 can be temperature measurement inputs and the switching can be effected by a comparison of actual value temperatures with setpoint values.

The fuel cells shown at 12 and the stacks shown at 13 can have different power parameters and characteristics and different nominal load points, especially with respect to current densities. This enables a wide variety of control combinations and thus enables all operating conditions of the loads to be met. The bridge circuits can also switch on and off individual cells within the stacks. For monitoring the electrical load 21, a network input device can be used which effects the turning on or off of the individual cells or stacks.

The fuel-cell system of the invention is of flexible and simple construction allowing economical control. The system can be fabricated by mass production techniques and allows any optimum load point for any special use to be maintained whether this is to maximize heating and/or current availability.

Expensive adjustment and matching operations can be eliminated and for special purposes, optimal load points can be determined by empirical techniques or calculations and stored in the memory of the controller. The controller can be a computer which at the time of installation allows parameters such as temperature limits, current densities, efficiencies, power ranges, times, hierarchies of loads, safety considerations and fuel current costs to be programmed in.

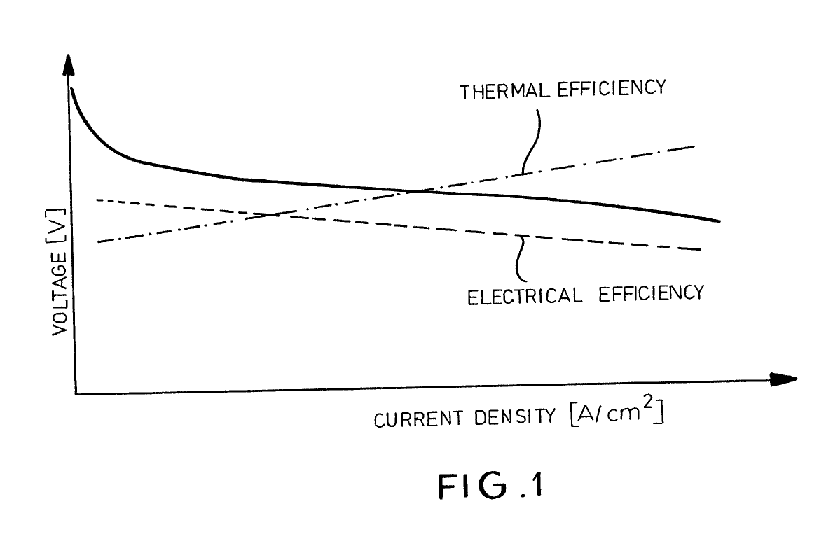

FIG. 1 shows the characteristic of a fuel cell. The current density is plotted versus voltage and, as is apparent, at the very electric current, heat is also produced. The characteristics decrease in electrical efficiency with increasing thermal efficiency and vice versa is apparent. The invention permits solely by the turning on and off of such fuel cells individually, the matching of the most effective load points.

We claim:

1. A method of controlling a fuel-cell system which comprises:
(a) connecting a multiplicity of individual electric power generating units selected from individual fuel cells and fuel-cell stacks in an assembly by electrical connections selected from series and parallel connections, thereby generating electric power and producing heat for at least one energy consuming load; and
(b) controlling power produced by said assembly to match an actual load point of said load and electrical current density required by said load exclusively by cutting off and turning on one or more of said units.

2. The method defined in claim 1, further comprising the step of monitoring operation of said energy consuming load, the power produced by said assembly being controlled in response to the monitoring of said operation.

3. The method defined in claim 1 wherein the cutting off and turning on of individual fuel cells or stacks is carried out so that the individual fuel cells or stacks remaining in operation bring the assembly as close as possible to the load point actually required for most effective operation of the energy consuming load in terms of actual energy utilization or for readiness for the maximum electrical and/or thermal energy which may be required.

4. The method defined in claim 1 wherein the cutting off and turning on of individual fuel cells or stacks is carried out in accordance with demand requirements of the electrical or thermal load and the individual fuel cells or stacks remaining in operation are operated as close as possible to the most effective load point in terms of demand requirements.

5. The method defined in claim 1 wherein, in the control of the fuel-cell system in response to a thermal load, the optimum load point for a maximum electrical efficiency is ignored to establish a greater thermal output, and in the control of the fuel-cell system in response to an electrical load the optimum load point for the greatest thermal efficiency is ignored to maximize electrical output.

6. The method defined in claim 1 wherein the stepwise cutting off and turning on of individual fuel cells or stacks is balanced by modulation of individual fuel cells or stacks remaining in operation.

7. The method defined in claim 1 wherein a temperature is measured in a region of interconnection of the thermal load to the assembly and/or in the thermal load, and the fuel-cell system is controlled in response to the measured temperature.

8. The method defined in claim 1 wherein the individual cells or stacks of said assembly have different power outputs and operating parameters.

9. The method defined in claim 1 wherein the individual cells or stacks of said assembly have different nominal load points.

10. A fuel-cell system comprising:
a multiplicity of individual electric power generating units selected from individual fuel cells and fuel-cell stacks connected in an assembly by electrical connections selected from series and parallel connections, thereby generating electric power and producing heat for at least one energy consuming load; and
respective bridges connected across said units for controlling power produced by said assembly to match an actual load point of said load and electrical current density required by said load exclusively by cutting off and turning on one or more of said units.

11. A fuel-cell system comprising:
a multiplicity of individual electric power generating units selected from individual fuel cells and fuel-cell stacks connected in an assembly by electrical connections selected from series and parallel connections, thereby generating electric power and producing heat for at least one energy consuming load; and
an electrical network monitor connected to an electrical member of said load for controlling power produced by said assembly exclusively by cutting off and turning on one or more of said units.
